(19) United States
(12) Patent Application Publication
(10) Pub. No.: US 2013/0092678 A1
(43) Pub. Date: Apr. 18, 2013

(54) System And Method For De-Icing Conductive Objects Utilizing At Least One Variable Resistance Conductor With High Frequency Excitation

(71) Applicant: THE TRUSTEES OF DARTMOUTH COLLEGE, Hanover, NH (US)

(72) Inventors: Victor F. Petrenko, Lebanon, NH (US); Charles R. Sullivan, West Lebanon, NH (US)

(73) Assignee: THE TRUSTEES OF DARTMOUTH COLLEGE, Hanover, NH (US)

(21) Appl. No.: 13/692,911

(22) Filed: Dec. 3, 2012

Related U.S. Application Data
(63) Continuation of application No. PCT/US2011/039168, filed on Jun. 3, 2011.
(60) Provisional application No. 61/351,288, filed on Jun. 3, 2010.

(51) Int. Cl. H02G 7/16; H01H 47/00

(52) U.S. Cl. CPC H02G 7/16; H01H 47/00
USPC 219/473; 219/492; 307/113

(57) ABSTRACT

A conductor of a power transmission line has its effective resistance to flow of direct current or low-frequency current (such as, for example, 50 Hz or 60 Hz) varied in a wide range to pass current and/or to generate heat for melting ice. Increasing the initial resistance of a conductor is accomplished by modulating the current at a high frequency (HF), such as about 1 kHz to about 100 kHz. The current through the conductor then becomes a mixture of a DC (or low-frequency current) and a high-frequency current. Because the latter flows in a thin skin-layer region of the conductor of depth dependent on frequency, the conductor's resistance to the HF current is higher than its resistance value for low frequency or DC current. By varying the frequency of current modulation in accordance with the present invention, the conductor's resistance is adjusted to a desired value for ice removal.

### RELATED APPLICATIONS

This application is a continuation of PCT Patent Application PCT/US2011/039168, filed Jun. 3, 2011, which claims priority to U.S. Provisional Patent Application 61/351,288, filed Jun. 3, 2010, the contents of which are incorporated herein by reference.

### FIELD OF THE INVENTION

The present invention relates generally to systems and methods for deicing conductive objects, such as power lines.

### BACKGROUND OF THE INVENTION

Ice storms, and other severe/extreme weather condition that often result in an accumulation of ice on structures, including overhead power transmission lines and associated poles and towers (with such ice accumulations reaching thicknesses of several inches or more), are fairly common in some parts of the world. Such ice storms fortunately represent only a small percentage of the total operating time of a power transmission line, and, in most temperate climate regions, any one particular power transmission line typically encounters such conditions only a few times per year.

During ice storms, the mass of accumulated ice causes significant problems by mechanically stressing cables and structures. For example, a 2″ cylinder of accumulated ice adds a weight of about 5.7 tons per mile to a 1″ conductor. The ice also alters a profile of the laden cable, increasing wind-induced stress, further raising the likelihood of the cable snapping, and/or of related support structures being severely damaged or collapsing. It is well known that accumulated ice frequently causes power transmission lines and poles to break, and towers to collapse; with any such breakage or collapse interfering with, and/or disrupting, power transmission in the affected region, and often also causing serious harm to persons and property in areas near such incidents.

In harsher climates, such as for example in many parts of Russia and China, conditions leading to dangerous ice accumulations on power lines and related structures are not only much more likely to occur, and with greater frequency, but also cause accumulation of greater thickness than elsewhere, thus posing commensurately higher risks of disruption of power transmission, and greater risks of collateral damage to local life and property.

Power transmission lines are normally designed to have a constant, low, overall resistance, so as to avoid excessive power losses and operation of wires at high temperatures. As a wire reaches high temperatures, whether due to electrical self-heating, high ambient temperatures, or both, it tends to lengthen and weaken. This lengthening can cause the lines to sag between poles or towers, possibly causing hazard to persons or property on the surface. Further, low resistance during normal operation is desirable to avoid excessive power losses: every kilowatt of electrical energy lost to heating of lines, is a kilowatt that must be generated, but that does not reach a customer. Finally, excessive voltage drops in transmission lines due to high resistance may cause instability of the power grid system.

Many power transmission lines have cables that have several individual conductors, often spaced several inches apart, and connected electrically in parallel for each phase. While allowing higher ampacity than single-conductor cables by improving cooling in high ambient temperatures, this design increases the amount of ice that may accumulate by providing additional surface for ice nucleation. For example, a system having two parallel transmission lines, each line having three cables with five conductors per cable separated by spacers, all coated with two inches of ice, could have over 172 tons of extra weight per mile. Furthermore, such a design may be incompatible with single-switch deicing techniques because only energized conductors, or conductors in thermal contact with energized conductors, receive the benefit of deicing.

Not only can the high weight and increased wind drag of iced-over lines cause breakage of lines and collapse of a tower, but the sudden shift in forces on a tower resulting from an initial break in a line or collapse of a pole or tower can cause additional, adjacent, towers or poles to crumple or topple in a cascade-like “chain reaction” manner. As a result, in many cases, repair crews arriving to a site of such incidents may find not just a single flattened tower, but the wreckage of a dozen or more adjacent towers tangled among downed lines.

Sudden collapses of transmission lines can also cause damage to switching equipment and power plants, and can lead to instability in power grids. Sudden collapse of a power transmission line can cause capacity losses and power grid instability significant enough to trigger either “rolling” blackouts or cascading blackouts extending over many nearby regions. It is therefore highly desirable to prevent, reduce, and/or remove, ice accumulation from power lines.

One advantageous solution for addressing the above challenge has been disclosed in the co-pending U.S. patent application Ser. No. 12/193,650, ('650) filed Aug. 18, 2008, entitled “System and Method for Deicing of Power Line Cables” of Victor Petrenko et al. This application disclosed and taught various embodiments of a system and method for deicing power transmission cables by first dividing the cables into sections, providing switches at each end of a section for coupling the conductors together in parallel in a normal mode, and at least some of the conductors coupled in series in an anti-icing mode. With the system of '650 in anti-icing mode an electrical resistance of each cable section is effectively increased allowing self-heating of the cable by power-line current to deice the cable. With the system of '650, the switches couple the conductors in parallel for less loss during normal operation. In an alternate embodiment, also disclosed in the '650 patent application, the system provided current through a steel strength core of each cable to provide deicing, while during normal operation current flows through low resistance conductor layers, with protective hardware being provided to return the system to low resistance operation should a cable over-temperature state occur.

Since the systems and methods of '650 operates by effectively increasing the electrical resistance of the cable in deicing mode, the systems and methods of '650 are known herein as Variable Resistance Cable (VRC) methods.

While the power line deicing approaches and techniques disclosed in the above-described '650 patent application are advantageous, they require use of odd number of wire strands in a bundle and require configurations with specific numbers of paralleled wire sets (e.g., 6, 12, 16, etc.). They also subject a line to high parallel line inductance. Some of these drawbacks are not present in alternate power line deicing solutions utilizing high frequency (HF) techniques, but such HF solutions have flaws of their own, such as very high cost, and potentially dangerously-high levels of electromagnetic emissions during operation.

Thus, it would be very desirable to provide a system and method for preventing, reducing, and/or removing, ice accumulation from power lines that combines the greatest advantages of VRC and HF-based deicing solutions, but that do not suffer from their significant drawbacks.

### BRIEF DESCRIPTION OF THE DRAWINGS

In the drawings like reference characters denote corresponding or similar elements throughout the various figures:

FIG. 1 shows a schematic diagram of a first exemplary embodiment of the inventive system for de-icing conductive objects utilizing at least one variable resistance conductor with high frequency excitation;

FIG. 2 shows a schematic diagram of a first exemplary embodiment of the inventive system for de-icing conductive objects utilizing at least one variable resistance conductor with high frequency excitation;

FIGS. 3A and 3B illustrate time dependence of the total current passing through the system of FIG. 2, in which zero current switching is achieved with approximately 50% duty cycle; and

FIG. 4 shows the fundamental component of time dependence of the total current passing through the system of FIG. 2, in a manner which illustrates the relationship between low and high frequency waveforms.

FIG. 5 illustrates a switchbox for a system implementing the method illustrated with reference to FIGS. 1-4.

FIG. 6 illustrates a system using the switchbox of FIG. 5 to implement the method of deicing transmission lines illustrated in FIGS. 1-4.

### DETAILED DESCRIPTION OF THE EMBODIMENTS

The present invention is directed to a system and method for de-icing conductive objects utilizing at least one variable resistance conductor with high frequency excitation, thus providing a solution for preventing, reducing, and/or removing, ice accumulation from power lines that combines the greatest advantages of VRC and HF-based deicing solutions, but that do not suffer from their significant drawbacks. The present powerline system has a deicing mode wherein the DC or low-frequency AC power is transmitted through a cable or conductor in chopped form, the chopping frequency chosen to take advantage of the “skin effect” of the conductor to confine current to an outer layer of the conductor, thereby increasing effective resistance of the conductor to transmitted power to the point where sufficient heat is generated in the outer layers of the conductor to deice the conductor. The system also has a normal operating mode where power is transmitted in unchopped form such that a greater volume of conductor carries the current and less heat is generated. Such a frequency-controlled conductor can be useful in many practical applications, for instance, in accordance with the present invention, for melting ice on conductors of transmission power lines.

In accordance with the present invention, changing the initial resistance to a higher resistance of a conductor to the flow of current is accomplished by modulating the current at a high frequency (HF) significantly higher than standard powerline frequencies such as by way of example about 1 kHz to about 100 kHz. For purposes of this document, standard powerline frequencies are in the range of 16 to 60 Hz, with 50 and 60 Hz being most common The current through the conductor then becomes a mixture of a DC (or low-frequency current) and a high-frequency current. Because the latter can only flow inside a thin skin-layer region of the conductor, the conductor's resistance to the HF current is higher than its resistance value for DC or low-frequency AC current. Therefore, by varying the frequency of current modulation in accordance with the present invention, the conductor's resistance may be varied as may be necessary or desired.

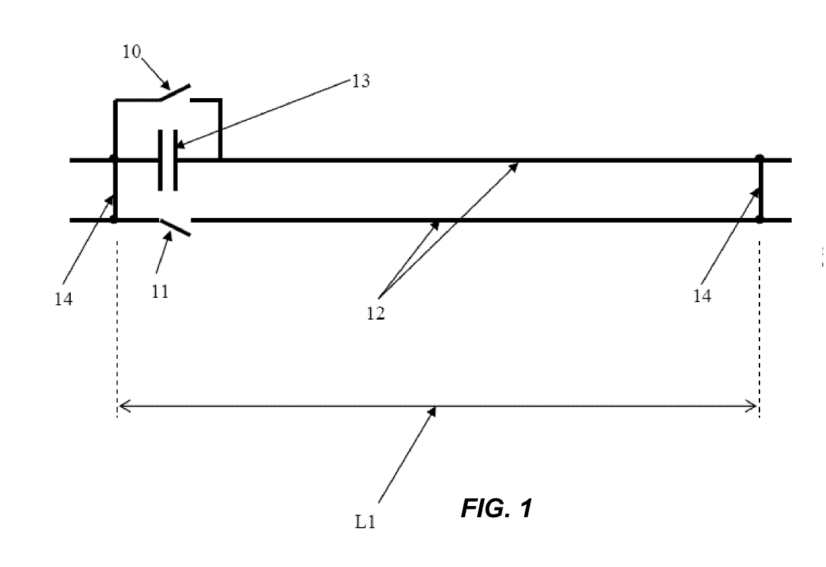

Referring now to FIG. 1, a schematic diagram is shown of a first exemplary embodiment of the inventive system and method for de-icing conductive objects, utilizing at least one variable resistance conductor with high frequency excitation (hereinafter “VRCwHFE System”), in which:
Component 10 is a first switch,
Component 11 is a second switch,
Components 12 are parallel conductors,
Component 13 is a capacitor,
Components 14 are electrical connectors,
and L1 is the length of one section of the inventive system having variable resistance.

In exemplary normal system operation, both first and second switches 10/11 (20/21) are closed and the VRCwHFE System conducts the current in the same manner as a conventional two-parallel-wire line. The resistance of the illustrated section of the line L1 to DC current, with switches 10 and 11 closed, is determined as follows:

$${R}_{D C} = \frac{2 ρ \cdot L}{π \cdot {d}^{2}} \qquad ( 1 )$$

where R_{DC} is line resistance to dc current, p is resistivity of the wires, L is length of the section, and d is the wire diameter.

In the variable-resistance mode of the inventive VRCwHFE System, switch (10/20) is open, and switch (11/21) rapidly alternates between open and closed positions at a high frequency f. When the switch 11/21 is open, the line current charges the capacitor 13, while when the switch 11 is closed, the capacitor 13 discharges through the lower conductor. Then the cycle is repeated.

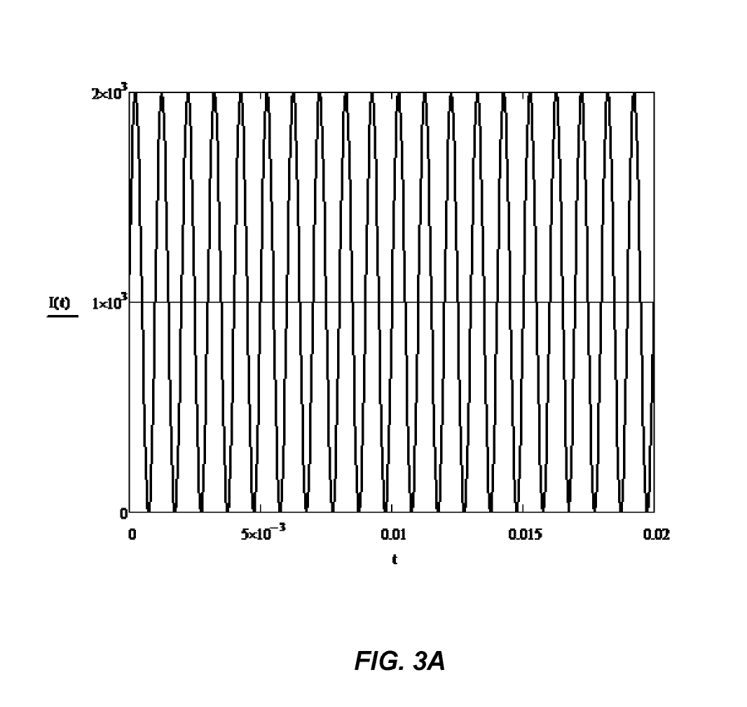

With the switching frequency F and capacitor (13/23) value appropriately chosen to match a resonant frequency of the inductance of the conductor loop (12/22) and the capacitor 13/23, it is possible to achieve zero-current switching (ZCS) in switch 11/21. The results of implementation of this technique are illustrated in FIGS. 3A and 3B, in which the current returns to zero at approximately the time that the switch 11/21 turns off.

Neglecting skin and proximity effects, the resistance of the loop where the HF-AC current flows is determined as follows:

$${R}_{Loop} = \frac{8 ρ \cdot L}{π \cdot {d}^{2}} \qquad ( 2 )$$

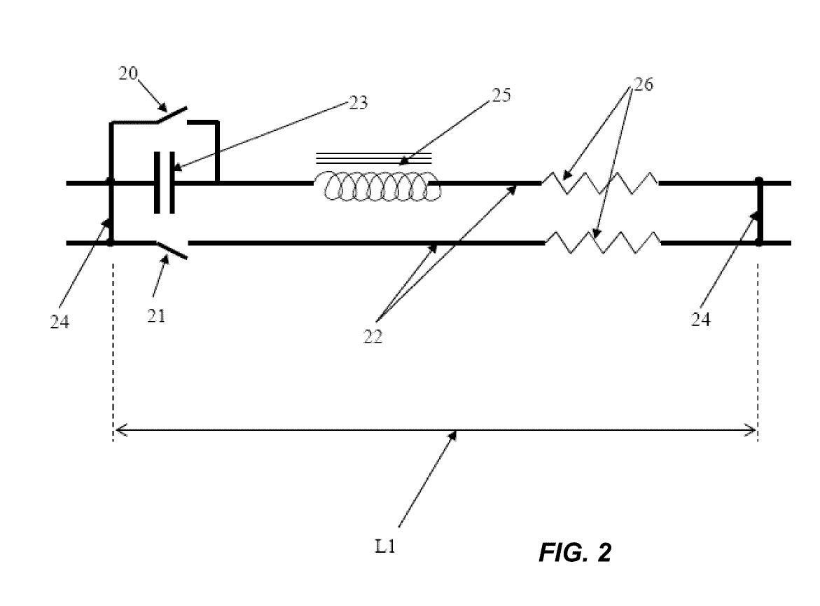

Referring now to FIG. 2, a schematic diagram is shown of a second exemplary embodiment of the inventive system and method for de-icing conductive objects utilizing at least one variable resistance conductor with high frequency excitation, in which:
Component 20 is a first switch
Component 21 is a second switch
Components 22 are parallel conductors
Component 23 is a capacitor of capacitance, C
Components 24 are electrical connectors
   25 is a parallel-wire induction, L
26 is each wire's resistance, R_{DC} for direct current, but R_{HF} for the HF-part of the current. and L1 is the length of one section of the inventive system having variable resistance

It should be noted that when the skin depth is less than the wire radius an approximate resistance of the loop to the HF-AC current can be determined as follows:

$${R}_{HF\_Loop} = \frac{8 ρ \cdot L}{π \cdot [ {d}^{2} - {( d - 2 δ )}^{2} ]} \qquad ( 3 )$$

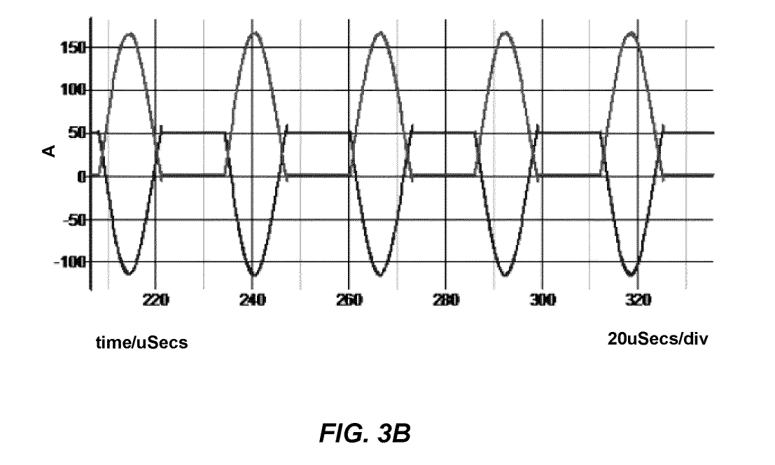

Referring now to FIGS. 3A, 3B, and 4, these figures graphically illustrate time dependence of the total current passing through the inventive two-wire line of FIG. 2. Specifically FIGS. 3A and 3B show a case in which ZCS is approximately achieved with an about 50% duty cycle. It is possible to operate with ZCS at different duty cycles by using a similar on-time of switch 21, to allow the current to resonantly return to zero, but with a different off-time of switch 21. The required on-time is set by the resonance of the capacitor (23) and the inductance of the loop (25), considering the damping provided by the resistances (26). The choice of capacitor value and off-time allows a range of different choices of frequency and harmonic content of the line current waveforms.

Referring now to FIG. 4, the manner in which the HF current is modulated by the low-frequency (e.g., 50 or 60 Hz) variation in line current is shown. It should be noted that while FIG. 4 does not accurately represent the HF current waveform, it does show the fundamental component thereof, in order to illustrate the relationship between low- and high-frequency waveforms (specifically, by way of example, FIG. 4 shows 50 Hz current modulated at high frequency when first switch 20 is open, while second switch 21 is opened and closed at a frequency of 1,000 Hz.)

For a waveform such as that shown in FIGS. 3A and 3B, the resistance to each harmonic would be calculated separately with the above equation (3). Specifically, by way of example only, FIGS. 3A and 3B, illustrate direct current modulated at high frequency when switch 20 is open, while switch 21 is opened and closed at a frequency of 38.46 kHz. The waveform of FIG. 3B is the current through the upper conductor and the capacitor; while waveform of FIG. 3A is the current through the switch and the lower conductor. These waveforms were based on an exemplary simulation with a 100 nF capacitor, 1-ohm resistance in each conductor, and a 100 microhenry inductance of the loop.

For de-icing applications, the heating power generated by the DC and AC currents can be approximately determined as follows:

P(f)=R_{DC}·I_{DC}²+R_{HF}_{_{—}}_{Loop}(f)·I(f)_{AC}² (4)

where I_{DC} is the DC or LF part of the total current and I_{HF} is root mean square (RMS) of the HF part of the current, f is the high switching frequency of second switch 21.

Thus, in accordance with the present invention, varying the frequency in a conductive object, such as a power line, can efficiently vary the effective resistance and heat dissipation of the line, and therefore the corresponding heating power production. The system and method of the present invention have the following advantages over previously known VRC and HF conductive object de-icing techniques:
(1) As compared to VRC, which can only work with either odd numbers of strands in a bundle or with 6, 12, 18 etc., the inventive system and method can work with any number of conductors greater than one in a bundle;
(2) As compared to a “high frequency only” deicing solution, the inventive system and method have at least the following advantages:
   (a) The switches and the capacitor are low-voltage (and thus low cost) devices. They don't “see” the total high voltage of the line, such as 500 kV. The inventive system can use devices rated at 1-kV;
   (b) The parallel-line inductance is much smaller, because it is defined by a small distance in between wires in a bundle, rather than by a large distance between two phases. Much smaller line inductance greatly improves the power factor of HF deicing;
   (c) Overall cost the inventive system will be at least 10 times cheaper than that of HF deicing; and
   (d) Because of much smaller distance between the strands, the electromagnetic emission of the inventive system is also much lower than that in HF-deicing.

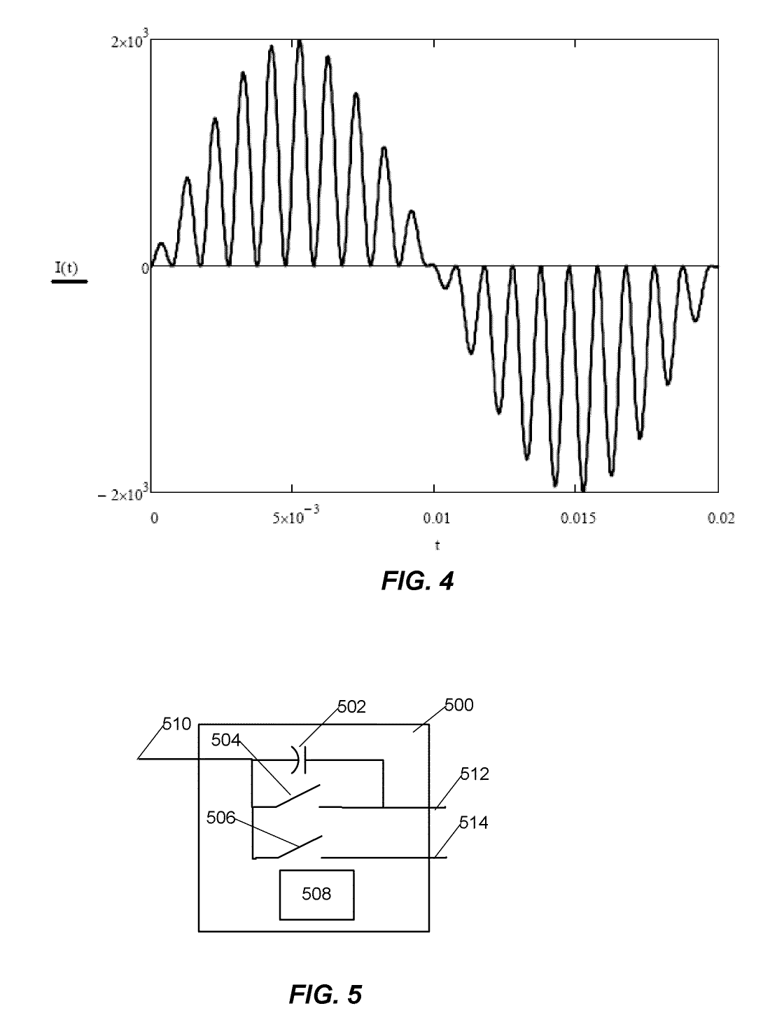

A switchbox 500 for implementing the method of deicing power transmission line cables heretofore described with reference to FIGS. 1-4 is illustrated in FIG. 5. Switchbox 500 contains a capacitor 502 for use as capacitors 13, 23 connected in parallel with a first switching device 504 for implementing first switch 10, 20. Switchbox 500 also contains and a second switching device 506 for implementing second switches 11, 21, and a switch-driver module 508. In an embodiment, each switching device 504, 506 has at least one electronic switching device such as a field-effect transistor, gate-turn-off triac, bipolar transistor, insulated-gate bipolar transistor, MOS controlled triac, or other electronic switching device as known in the art of power electronics and capable of rapid switching under control of switch-driver module 508. In a particular embodiment, each switching device 504, 506 also has an electromechanical switch (not shown) in parallel with its electronic switching device to permit low-resistance normal operation of the power line. Switch-driver module 508 has a receiver for a control signal, an actuator for any electromechanical switch (not shown), and driver electronics for driving switching devices 504, 506 to enable deicing mode and to drive switching device 506 at one or more frequencies f to deice the power line.

The switchbox 500 receives power from a power input terminal 510, and is coupled through a first 512 and second 514 output terminal to conductors of a power transmission line. In an embodiment, first switching device 504 and capacitor 502 are coupled between input terminal 510 and first output terminal 512, and second switching device 514 between input terminal 510 and second output terminal 514. Alternative embodiments of switchbox 500 may include additional capacitors and additional switches for deicing additional conductors of the power transmission line.

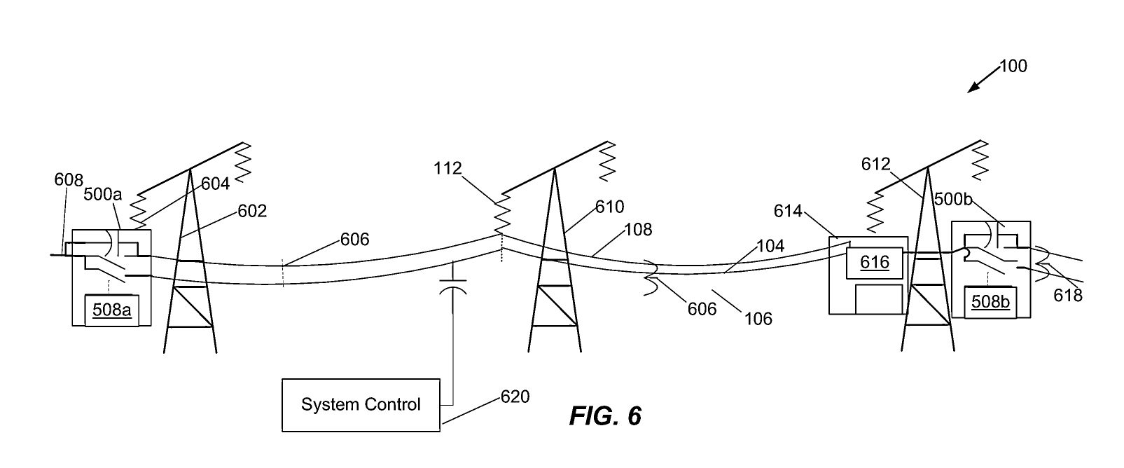

A system 600 utilizing switchbox 500 is illustrated in FIG. 6. A first switchbox 500a having switch-driver module 508a, a capacitor, and switching devices as illustrated in FIG. 5 is suspended from a tower 602 of a transmission line by an insulator 604 at a start of a first deicable section of the transmission line. The first deicable section has cables 606 and receives power from a previous deicable section, a substation, or other input 608. The deicable section may extend through one span between towers 602, 610, 612, or through several spans. Each deicable section ends in a connector box 614 containing a connection corresponding to connector 14, 24 and which may contain a low-pass filter 616 for preventing high-frequency components from propagating further down the power transmission line, connector box 614 is also suspended by an insulator from a tower 612. The system may have more than one deicable section, such as second section 618, for which a second switchbox 500b serves as a beginning, second switchbox 500b having a second switch-driver module 508b. The system also has a system controller 620 that is in communication with switch-driver modules 508a, 508b.

In operation, when deicing is desired, system controller 620 transmits a deicing-command message to one or more switch-driver modules 508, 508a, 508b in one or more switchboxes 500, 500a, 500b. Switch-driver modules receiving the deicing command message then open their first switch 504 and intermittently open their second switch 506 at a frequency f determined to provide adequate deicing power to cables 606. In a particular embodiment, frequency f is determined by the system controller 620 and transmitted to switch-driver modules in the deicing command message; in an alternative embodiment frequency f is determined by each receiving switchbox; in these embodiments frequency f is higher for higher desired deicing power, and lower for lower desired deicing power. In an embodiment, frequency f is determined both according to desired deicing power and current in the transmission line.

Once deicing is complete for one or more sections of the cable, system controller 620 transmits a normal-mode command message to those switch-driver modules 508, 508a, 508b associated with those sections of the cable for which deicing is complete. Upon receiving a normal-mode command message, or when an overtemperature condition in a switchbox 500 is detected by the switch-driver module 508 of that switchbox, or when a system timeout occurs, the switch-driver module 508, 508a, 508b of switchbox 500, 500a, 500b returns the switchbox to a normal condition by closing both switching devices 504, 506 and closing any paralleled electromechanical switches.

In an embodiment, system controller 620 has input from ice-detecting sensors distributed at predetermined locations along cables or conductors of the power transmission line. Once ice of thickness requiring deicing is detected along the cables, or a manual “deice-now” control is activated, the system controller determines a deicing sequence for the multiple independently-deicable sections of the transmission line, where each independently deiceable section has at least one switchbox 500. The system controller then sends a deicing message to the module controller of the switchbox 500 of the first deicable section of the transmission line, and when deicing is complete for that section sends a normal mode command to the module controller of the switchbox of the first deicable section, and a deicing message to the module controller of the switchbox 500b of the next deicible section requiring deicing; the sections thereby being deiced according to the determined deicing sequence.

In an embodiment, the system controller has a table of chopping or switching frequency f as a function of current, the table having been calculated using equation 4 above and known skin-effect effective resistance versus frequency characteristics R_{HF}_{_{—}}_{Loop}(f) (which may have been measured or may have been calculated according to equation 3 above) of the cables or conductors of each section. The frequency f provided by the table for each current I is calculated to provide an effective resistance sufficient to provide a heating power appropriate for deicing the cable or conductors. The system controller then measures current I in the transmission line. The controller then uses a table interpolation algorithm in the table to determine an appropriate frequency f, frequency f generally being lower for higher current I. A digital code indicating the resulting frequency f is transmitted with the deicing message to each module controller.

Various specific embodiments of the system and method described herein have the following characteristics:

In an embodiment designated A, a switchbox for system for transmitting power into a deicable section of a transmission line has a power input terminal 510, a first 512 and second 514 output terminal, a first switching device 504 and a capacitor 502 coupled in parallel between input terminal 510 and first output terminal 512, a second switching device 506 between input terminal 510 and second output terminal 514, and a switch-driver module with circuitry for driving the first and second switching devices 504, 506. In this embodiment the switch-driver module has a first operating mode where both the first and second switching devices are held closed, and a second operating mode where the first switching device is held open while the second switching device is alternately opened and closed at a determined frequency significantly higher than standard powerline frequencies.

In an embodiment designated B, the switchbox designated A has a switch-driver module with a receiver for a deicing control signal, and wherein the switch-driver module is configured to enter the second operating mode upon receiving the deicing control signal.

In an embodiment designated C of a transmission line system having the switchbox embodiments designated A or B, in a transmission line further comprising at least one deicable section of cables, the deicable section with a switchbox as in the embodiments designated A and B located at a first end of the deicable section, a first conductor, a second conductor, and a connection between the first and second conductor at a second end of the deicable section.

In an embodiment designated D of the system designated C the switch-driver module has a receiver for the deicing control signal, and the system also has a system controller for transmitting the deicing control signal to the switch-driver module.

In an embodiment designated E, the system designated C or D has ability to determine a frequency for switching of the second switching device of each switchbox according to a desired power dissipation in the cables.

The embodiments designated C and D implement a method for deicing at least one conductive object, the transmission line, of a predetermined length, comprising selectively varying effective electrical resistance of the at least one conductive object along said predetermined length, the effective resistance determined by determining a frequency of a current flowing therethrough within a predefined frequency range and modulating power transmitted along the conductive object at that determined frequency.

Thus, while there have been shown and described and pointed out fundamental novel features of the inventive apparatus as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A switchbox for transmitting power into a deicable section of a transmission line, the switchbox comprising:
a power input terminal,
a first and second output terminal,
a first switching device and a capacitor coupled in parallel between input terminal and first output terminal,
a second switching device is coupled between input terminal and second output terminal,
a switch-driver module comprising circuitry for driving the first and second switching devices, the switch-driver module having a first operating mode where both the first and second switching devices are held closed, and a second operating mode where the first switching device is held open while the second switching device is alternately opened and closed at a determined frequency significantly higher than standard powerline frequencies.

2. The switchbox of claim 1 wherein the switch-driver module further comprises a receiver for a deicing control signal, and wherein the switch-driver module is configured to enter the second operating mode upon receiving the deicing control signal.

3. A system comprising:
a transmission line further comprising at least one deicable section, the deicable section further comprising a switchbox according to claim 2 located at a first end of the deicable section, a first conductor, a second conductor, and a connection between the first and second conductor at a second end of the deicable section.

4. The system of claim 3 wherein the switch-driver module has a receiver for the deicing control signal, and the system further comprises:
a system controller for transmitting the deicing control signal to the switch-driver module.

5. The system of claim 4 wherein the switch-driver module of at least one switchbox has ability to switch the second switching device at a frequency determined according to a desired power dissipation in the conductors of the deicable section of the transmission line.

6. The system of claim 3 wherein the switch-driver module of at least one switchbox has ability to switch the second switching device at a frequency determined according to a desired power dissipation in the conductors of the deicable section of the transmission line.

7. A system comprising a transmission line further comprising at least one deicable section, the deicable section further comprising a switchbox according to claim 1 located at a first end of the deicable section, a first conductor, a second conductor, and a connection between the first and second conductor at a second end of the deicable section.

8. The system of claim 7 wherein the switch-driver module has a receiver for the deicing control signal, and the system further comprises:
a system controller for transmitting the deicing control signal to the switch-driver module.

9. The system of claim 8 wherein the switch-driver module of at least one switchbox has ability to switch the second switching device at a frequency determined according to a desired power dissipation in the conductors of the deicable section of the transmission line.

10. The system of claim 7 wherein the switch-driver module of at least one switchbox has ability to switch the second switching device at a frequency determined according to a desired power dissipation in the conductors of the deicable section of the transmission line.

11. A method for deicing at least one conductive object of a predetermined length, comprising:
selectively varying an effective electrical resistance of the at least one conductive object along said predetermined length, the effective electrical resistance determined by determining a frequency of a high-frequency alternating current flowing therethrough within a predefined frequency range and modulating power transmitted along the conductive object at that determined frequency.

12. The method of claim 11 wherein the conductive object is cable of a power transmission line having at least a first and a second conductor.

13. The method of claim 12 wherein the first conductor of the power transmission line is coupled to a first terminal of a switchbox, the second conductor of the power transmission line is coupled to a second terminal of a switchbox, and the high-frequency alternating current is applied to the conductors by rapidly interrupting a current flowing from a third terminal of the switchbox through the switchbox into the conductors.
